(19) United States
(12) Patent Application Publication
(10) Pub. No.: US 2021/0031507 A1
(43) Pub. Date: Feb. 4, 2021

(54) IDENTIFYING DIFFERENCES BETWEEN IMAGES

(71) Applicant: Hewlett-Packard Development Company, L.P., Spring, TX (US)

(72) Inventors: Oren Haik, Nes Ziona (IL); Oded Perry, Nes Ziona (IL); Eli Chen, Nes Ziona (IL)

(73) Assignee: Hewlett-Packard Development Company, L.P., Spring, TX (US)

(21) Appl. No.: 17/042,993

(22) PCT Filed: Apr. 25, 2018
(86) PCT No.: PCT/US2018/029263

§ 371 Date: Sep. 29, 2020

(51) Int. Cl. B41F 33/00; G06T 7/00; G06N 3/08

(52) U.S. Cl. CPC B41F 33/0036; G06T 7/001; G06T 2207/20084; G06T 2207/30144; G06T 2207/30168; G06N 3/08

(57) ABSTRACT

A method is disclosed. The method may comprise obtaining first image data representing a reference image to be printed on a substrate. The method may comprise obtaining second image data representing a scanned image of a substrate on which the reference image has been printed. The method may comprise combining the first image data and the second image data to generate combined image data. The method may comprise providing the combined image data as an input to a classifier component to identify a difference between the first image data and the second image data. An apparatus and a machine-readable medium are also disclosed.

### BACKGROUND

A printing apparatus may be used to print a target image on a printable substrate. Printing defects in the printed image may be detected by comparing the target image with the print image.

### BRIEF DESCRIPTION OF DRAWINGS

Examples will now be described, by way of non-limiting example, with reference to the accompanying drawings, in which:

FIG. 1 is a simplified illustration of processes performed in relation to a printing system;

FIG. 2 is a flowchart of an example of a method of identifying differences between images;

FIG. 3 is a flowchart of a further example of a method of identifying differences between images;

FIG. 4 is a simplified schematic of an example of an apparatus for identifying differences between images; and

FIG. 5 is a simplified schematic of a machine-readable medium and a processor.

### DETAILED DESCRIPTION

A print apparatus may print an image onto a printable medium, or substrate, by depositing print agent, such as ink, from a nozzle or nozzles of a print agent distributor, or print head. The image to be printed onto the substrate may be referred to as a target image.

A target image (e.g. an image that it is intended is to be printed by the print apparatus) may be provided to the print apparatus in the form of image data, for example as a computer-readable file. The target image may contain colour data, and colours used within the target image may be defined according to a CMYK (i.e. cyan, magenta, yellow and black) colour model or colour space, or an RGB (red, green and blue) colour model or colour space. Other colour spaces may be used in other examples. In some examples, an image may be converted from one colour space into another colour space; for example from CMYK into RGB. Examples described herein use the RGB colour space; however, any colour space could be used. According to the RGB model, each colour is defined in terms of the amount of red (R), green (G) and blue (B) that makes up the colour. Within the target image, each pixel may be defined in terms of red, green and blue channels; the visible colour of a particular pixel within the target image depends on the values of the R, G and B channels for that pixel.

Print defects may occur, particularly when printing large numbers of substrates. A print defect may be an imperfection in the printed image, or a difference between the image that is printed and the image that is intended to be printed (i.e. the target image). According to examples disclosed herein, differences between the target image and the printed image may be identified using a classifier, such as a neural network classifier. Such a classifier may be trained to identify any differences between the target image and the printed image, classify the differences as being either true defects or false alarms and, if a difference is classified as a true defect, then providing an indication of the location of the defect in the printed image. As used herein, the term “true defect” is intended to refer to a defect resulting from the printing operation, such as a colour imperfection, smudged print agent, areas which have not been printed correctly due to a nozzle blockage, debris on the substrate, and the like. The term “false alarm” is intended to refer to a difference between the target image and the printed image which has not resulted from the printing operation. Such a false alarm may be caused, for example, by a scan artefact introduced during the process of scanning the printed image for comparison.

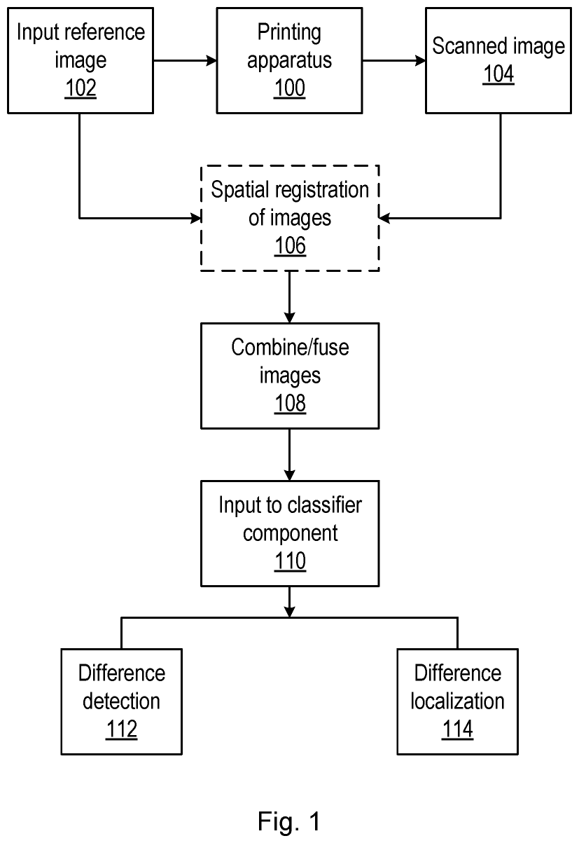

A print apparatus and a series of processes are shown schematically in FIG. 1. In FIG. 1, a print apparatus 100 is provided with an input reference image 102 to be printed onto a substrate. The input reference image 102 represents the target image to be printed and may, for example, be provided in the form of image data in an image file. The print apparatus 100 prints the reference image (i.e. the target image) onto a substrate, such as paper or a web-fed substrate. The printed substrate may be scanned using a suitable scanning apparatus which may, in some examples, form part of the print apparatus 100. The scanning apparatus generates as its output a scanned image 104 of the printed substrate. The scanned image 104 may be in the form of image data in an image file.

In order to determine whether or not the image printed onto the substrate contains any print defects (e.g. true defects), the scanned image 104 of the printed substrate may effectively be compared with the input reference image 102. Any differences between the scanned image 104 and the reference image 102 may be indicative of a print defect. If a print defect is detected, then it might be intended to temporarily prevent further substrates from being printed, or to take some other action to prevent further print defects from occurring.

In some examples, the reference image 102 and the scanned image 104 may be compared more accurately if the images are correctly aligned with one another. Thus, the reference image 102 and the scanned image 104 may be spatially registered with one another, as indicated in block 106. In some examples, spatial registration 106 may not be necessary and, as such, is considered to be optional, as indicated by the dashed lines. In some examples, other pre-processing techniques may be used to help to accurately detect differences between the reference image 102 and the scanned image 104.

As noted above, a classifier may be used to detect any differences between the reference image 102 and the scanned image 104. The reference image 102 may include colours defined using the RGB colour model and, therefore, the reference image may have three channels—a red channel, a green channel and a blue channel. Similarly, the scanned image 104 may include colours defined using the RGB colour model and, therefore, the scanned image may also have three channels. A classifier, such as a neural network model is able to receive a single input, such as an image file having three channels. Therefore, in order to provide image data representing both the three-channel reference image 102 and the three-channel scanned image 104 as an input to the classifier, the image data may be processed in order to obtain a single three-channel image. Thus, at block 108, the reference image 102 and the scanned image 104 may be combined or fused with one another using techniques discussed herein in order to obtain a combined or fused image suitable for serving as an input to the classifier.

At block 110, the combined image (i.e. the output from block 108) is input to a classifier component which may, for example, comprise a classifier such as a neural network classifier or a deep neural network classifier. The classifier component may, in some examples, be referred to as a classifier model, a classifier unit, or a classifier module.

Neural networks or, artificial neural networks, will be familiar to those familiar with machine learning, but in brief, a neural network is a type of model that can be used to classify data (for example, classify, or identify the contents of image data). Neural networks are comprised of layers, each layer comprising a plurality of neurons, or nodes. Each neuron comprises a mathematical operation. In the process of classifying a portion of data, the mathematical operation of each neuron is performed on the portion of data to produce a numerical output, and the outputs of each layer in the neural network are fed into the next layer sequentially. Generally, the mathematical operations associated with each neuron comprise a weight or multiple weights that are tuned during a training process (e.g. the values of the weights are updated during the training process to tune the model to produce more accurate classifications).

For example, in a neural network model for classifying the contents of images, each neuron in the neural network may comprise a mathematical operation comprising a weighted linear sum of the pixel (or in three dimensions, voxel) values in the image followed by a non-linear transformation. Examples of non-linear transformations used in neural networks include sigmoid functions, the hyperbolic tangent function and the rectified linear function. The neurons in each layer of the neural network generally comprise a different weighted combination of a single type of transformation (e.g. the same type of transformation, sigmoid etc. but with different weightings). In some layers, the same weights may be applied by each neuron in the linear sum; this applies, for example, in the case of a convolution layer. The weights associated with each neuron may make certain features more prominent (or conversely less prominent) in the classification process than other features and thus adjusting the weights of neurons in the training process trains the neural network to place increased significance on specific features when classifying an image. Generally, neural networks may have weights associated with neurons and/or weights between neurons (e.g. that modify data values passing between neurons).

In some neural networks, such as convolutional neural networks, which are a form of deep neural networks, lower layers such as input or hidden layers in the neural network (i.e. layers towards the beginning of the series of layers in the neural network) are activated by (i.e. their output depends on) small features or patterns in the portion of data being classified, while higher layers (i.e. layers towards the end of the series of layers in the neural network) are activated by increasingly larger features in the portion of data being classified. As an example, where the data comprises an image, lower layers in the neural network are activated by small features (e.g. such as edge patterns in the image), mid-level layers are activated by features in the image, such as, for example, larger shapes and forms, whilst the layers closest to the output (e.g. the upper layers) are activated by entire objects in the image.

Generally, neural network models may comprise feed forward models (such as convolutional neural networks, auto-encoder neural network models, probabilistic neural network models and time delay neural network models), radial basis function network models, recurrent neural network models (such as fully recurrent models, Hopfield models, or Boltzmann machine models), or any other type of neural network model comprising weights.

Referring again to FIG. 1, the classifier component may provide various outputs. The classifier component may provide, as a first output, at block 112, an indication of an identified difference between the input reference image 102 and the scanned image 104. The classifier component may classify the difference as being either a true defect (e.g. a printing defect) or a false alarm (e.g. a scanning artefact). In some examples, the classifier component may not provide such an output if it is determined that an identified difference is merely a false alarm. The classifier component may provide, as a second output, at block 114, an indication of a location of the identified difference or defect. For example, the classifier component may generate a bounding box around the identified difference or defect, to be displayed to a user.

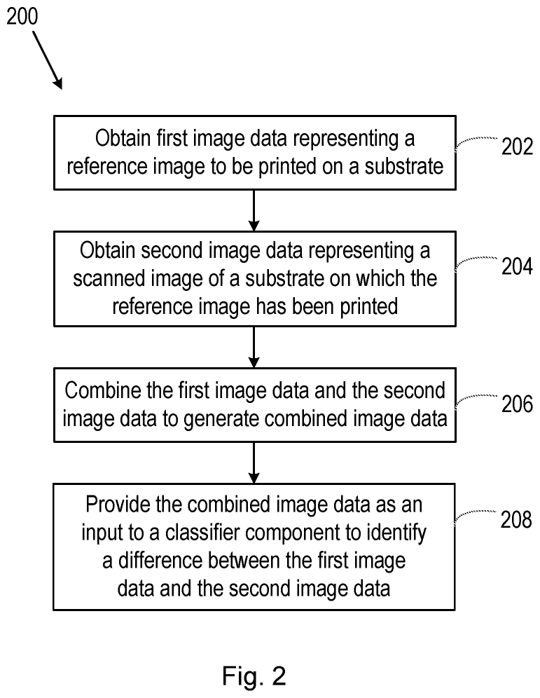

The processes described with reference to FIG. 1 may be defined in terms of a method. FIG. 2 is a flowchart of an example of such a method 200. The method 200 may, in some examples, considered to be a method for identifying differences between images. The method 200 comprises, at block 202, obtaining first image data representing a reference image to be printed on a substrate. Obtaining the first image data (at block 202) may be performed using processing apparatus. The reference image may, for example, comprise the input reference image 102 discussed above. The first image data may, in some examples, be in the form of an image file. Such an image file may be obtained from a storage device (e.g. a memory) using a processor, or provided manually by a user, for example by uploading the image file.

At block 204, the method 200 comprises obtaining second image data representing a scanned image of a substrate on which the reference image has been printed. Obtaining the second image data (at block 204) may be performed using processing apparatus. The scanned image may, for example, comprise the scanned image 104 discussed above. Thus, after the reference image has been printed onto the substrate, for example using the printing system 100 discussed above, a scanning apparatus may be used to scan the printable substrate in order to generate the scanned image. The scanned image may then be provided by the scanning apparatus to the processing apparatus performing the method 200.

The method 200 comprises, at block 206, combining the first image data and the second image data to generate combined image data. As noted above, the classifier component, in some examples, is capable of receiving an input in the form of a single three-channel image. The reference image and the scanned image may each comprise three-channel images (e.g. red, green and blue channels), and combining the first image data and the second image data enables a single three-channel combined image to be generated which is capable of being provided as an input to the classifier component.

Various approaches may be used to combine or fuse the first image data and the second image data. One example image combining technique is described below. According to this example, the reference image (i.e. the first image data) and the scanned image (i.e. the second image data) are compressed in order to reduce the number of channels in each image from three to one. For example, the R, G and B channels of the reference image may be compressed into a single, greyscale reference image channel, and the R, G and B channels of the scanned image may be compressed into a single, greyscale scanned image channel. In some examples, compression of the reference image and the scanned image may be performed using principal component analysis (PCA). In other examples, other compression techniques may be used. To form the combined image, for each pixel in the combined image, the value of one of the three channels (e.g. the green channel) is set equal to the value of the single, greyscale scanned image channel of the corresponding pixel in the scanned image. Similarly, for each pixel in the combined image, the values of the other two of the three channels (e.g. the red and blue channels) are set equal to the value of the single, greyscale reference image channel of the corresponding pixel in the reference image. It will be appreciated that, in other examples, a different one of the three channels (e.g. the red or blue channel) may be set equal to the greyscale scanned image channel and the other two channels may be set equal to the greyscale reference image channel.

Put more generally, combining the first image data and the second image data (at block 206) may comprise converting the first image data into first grayscale image data and converting the second image data into second grayscale image data. The combining performed at block 206 may further comprise applying the first grayscale image data as first and second channels of the combined image data; and applying the second grayscale image data as a third channel of the combined image data. As noted above, combining the first image data and the second image data may, in some examples, comprise applying principal component analysis (PCA) to the first image data and the second image data. PCA is used to compress the image data while preserving relevant data elements. In examples described herein, PCA is used to reduce the colour data in the scanned image and the reference image from three dimensions (RGB) to a single dimension (greyscale). In other examples, however, other compression techniques may be used.

The resulting combined image is formed of a combination of the reference image and the scanned image. Regions in the combined image where the reference image and the scanned image are identical will appear in greyscale. However, in the example described above, regions in the combined image where the reference image in the scanned image differ have will a green or magenta appearance. In this way, the combined image may be considered to be a pseudo-colour image, as the true (i.e. RGB) colours of the reference image are not apparent.

At block 208, the method 200 comprises providing the combined image data as an input to a classifier component to identify a difference between the first image data and the second image data. As discussed above, the classifier component may comprise a model or set of rules or instructions, such as a machine learning model. In some examples, the classifier component may comprise a neural network model. In some examples, the classifier component may comprise a deep neural network model, such as a convolutional neural network model.

The classifier component may be obtained by training a machine learning model (e.g. a neural network model) using training data. The model may be trained such that the resulting classifier component is capable of detecting true defects in the printed image, which are visible in the scanned image, and are represented by a difference between the scanned image and the reference image. In some examples, a training data set may include a plurality of combined images (i.e. pseudo-colour images generated, for example, in the manner described above) in which true defects have been labelled or annotated by drawing bounding boxes around the true defects. The training data may be provided to the machine learning model so that the model can be trained using a transfer learning process.

In some examples, the classifier component may comprise an object detection model referred to as a single shot detector (SSD). A single shot detector uses a single deep neural network to detect a candidate defect in an image and to classify the candidate defect as either a true defect or a false alarm. In some examples, the classifier component may be trained to ignore, or at least take no action (e.g. provide no output) in respect of, candidate defects which are considered to be false alarms.

Taking the example given above, the classifier component (e.g. once trained) may receive a pseudo-colour combined image representing a combination of an input image and a scanned image. The classifier component may detect any coloured (e.g. magenta or green) regions of the combined image and designate those regions as candidate defects. The coloured regions represent differences between the reference image and the scanned image that, together, make up the combined image. The classifier component may then classify those candidate defects (i.e. the differences) as true defects or false alarms. Thus, in some examples, the classifier component may be to provide as an output an indication that an identified difference between the reference image and the scanned image represents a defect in the scanned image.

The classifier component may, in some examples, be to provide as an output an indication of a location of a difference between the reference image and the scanned image. For example, the classifier component may generate a bounding box around any true defects. In other examples, the classifier component may indicate the location of a difference, or of a true defect, in some other way, such as by shading the difference.

Implementations of the classifier component may include electronic circuitry (i.e., hardware) such as an integrated circuit, programmable circuit, application integrated circuit (ASIC), controller, processor, semiconductor, processing resource, chipset, or other type of hardware component capable of identifying a difference between two images. In other examples, the classifier component may include instructions (e.g., stored on a machine-readable medium) that, when executed by a hardware component (e.g., controller and/or processor) causes any difference between the two images to be identified, accordingly.

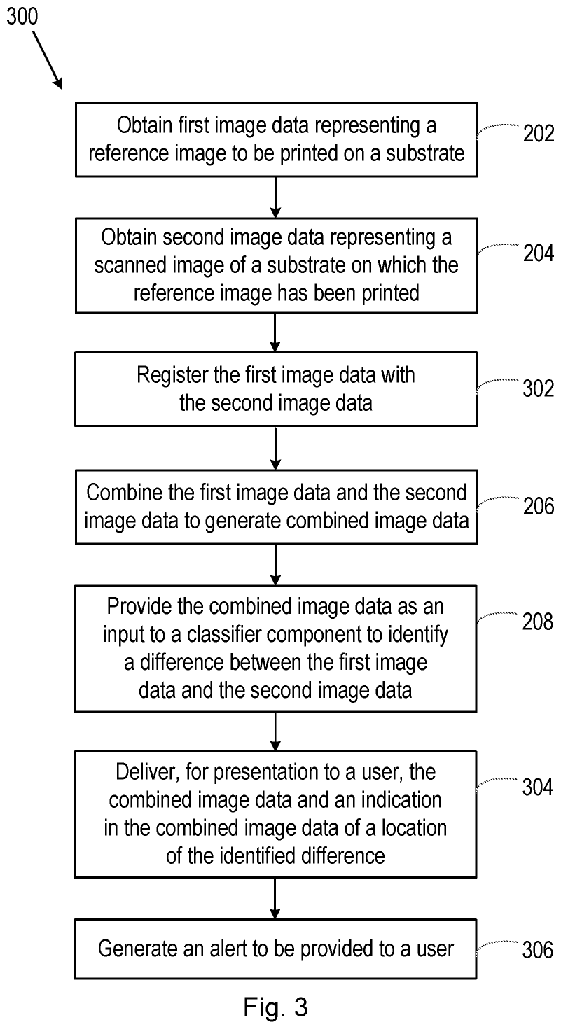

FIG. 3 is a flowchart of a further example of a method 300 of identifying differences between images. The method 300 may comprise blocks from the method 200 above. The method 300 may, in some examples, comprise, at block 302, registering the first image data with the second image data. The registering of block 302 may be similar to the process discussed with reference to block 106 above. The registration (block 302) may be performed prior to combining the first and second image data at block 206. Registration, which may also be referred to as spatial registration, may first involve modifying one or both of the reference image and the scanned image so that both images have the same resolution. The registration process may then involve locating the reference image in the scanned image and aligning the images using a series of registration techniques. A coarse alignment may be achieved using a global template matching process. A fine alignment may then be achieved using a local template matching process. The fine alignment may, in some examples, involve dividing one of the images into a plurality of (e.g. 15) non-overlapping blocks, and performing a fast unique and robust local template matching process.

The method 300 may, in some examples, comprise, at block 304, responsive to the classifier component identifying a difference between the first image data and the second image data, delivering, for presentation to a user, the combined image data and an indication in the combined image data of a location of the identified difference. Thus, the combined image may be annotated with bounding boxes shown around any identified true defects, and displayed to a user. Upon reviewing the combined image including the indication of the defect, the use may choose to take remedial action, such as halting the print apparatus, for example.

At block 306, the method 300 may comprise, responsive to the classifier component identifying a difference between the first image data and the second image data, generating an alert to be provided to a user. Thus, in addition to, or instead of, delivering the combined image for presentation to a user, the method may involve alerting a user if a difference (e.g. true defect) is detected. Such a defect may, for example, be indicative of a printing malfunction so, by alerting a user, the user is able to take remedial action, such as halting the print apparatus, to prevent further defective substrates from being printed. In other examples, other actions may be taken in response to the classifier component identifying a difference between the first image data and the second image data. For example, the method 300 may comprise automatically halting the print apparatus without informing (i.e. alerting or presenting the combined image to) a user.

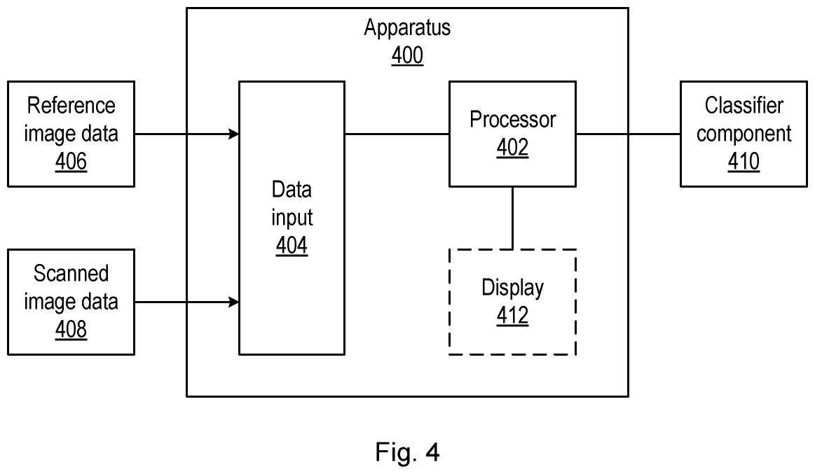

According to a further aspect, an apparatus is disclosed. FIG. 4 is a simplified schematic of an example of an apparatus 400. The apparatus 400 may be considered to be an apparatus for identifying differences in images. In general, the apparatus 400 may be to perform the methods 200, 300 disclosed herein.

The apparatus 400 comprises a processor 402 and a data input unit 404. The data input unit 404 is to receive reference image data 406 representing a three-channel reference image to be printed onto a printable substrate. For example, the data input unit 404 may receive data describing the input reference image 102 discussed above. The data input unit 404 is also to receive scanned image data 408 representing a three-channel scanned image of a printable substrate on which the reference image has been printed during a printing operation. For example, the data input unit 404 may receive data describing the scanned image 104 discussed above. In some examples, the scanning apparatus which scans the printed substrate may deliver the scanned image data to the data input unit 404. The data input unit 404 may be implemented using electronic circuitry (i.e., hardware) such as an integrated circuit, programmable circuit, application integrated circuit (ASIC), controller, processor, semiconductor, processing resource, chipset, or other type of hardware component. In some examples, the data input unit may form part of the processor 402.

The term “three-channel” describes the colour mode of the images. In this example, an RGB colour mode is used and, therefore, the three channels of the reference image data and the scanned image data comprise red, green and blue channels.

The processing apparatus 402 is to combine the reference image data 406 and the scanned image data 408 to form combined image data representing a three-channel combined image. The processing apparatus 402 is to input the combined image data into a classifier component 410 to identify a difference between the reference image data 406 and the scanned image data 408 and to provide an indication of a location of the difference in the combined image. The classifier component 410 may comprise, or be similar to, the classifier component discussed above with reference to block 110 of FIG. 1. For example, the classifier component 410 may comprise a neural network model, such as a deep neural network model. As discussed above, the classifier component 410 may be trained using training data to identify differences in the reference image data and the scanned image data.

In some examples, combining the reference image data 406 and the scanned image data 408 may comprise converting the reference image data into grayscale reference image data, and converting the scanned image data into grayscale scanned image data. In some examples, this may be achieved using principal component analysis (PCA) techniques. By converting the image data into greyscale image data effectively converts each image (i.e. the reference image and the scanned image) from a three-channel image into a single channel image. In other words, the red, green and blue channels of each image are converted into a single channel. Combining the reference image data 406 and the scanned image data 408 may further comprise setting the grayscale reference image data as first and second channels of the combined image data, and setting the grayscale scanned image data as a third channel of the combined image data. Thus, two channels of the combined image are formed from the greyscale image data of the reference image, and the third channel of the combined image is formed from the greyscale image data of the scanned image. As discussed above, the combined image will appear in greyscale if the reference image and the scanned image are identical; any differences between the reference image and scanned image will appear as a coloured region, the colour depending on which image data is applied to which channel in the combined image.

The apparatus 400 may, in some examples, further comprise a display 412 to display to a user the combined image and the indication of the location of the difference in the combined image. The display 412 may, for example, comprise a screen, a touch screen, or some other display device capable of presenting image data. In some examples, the apparatus 400 may comprise a computing device, such as a desktop computer, a laptop computer or a smart phone. Thus, the display 412 may comprise a display of such a computing device. In other examples, methods disclosed herein may be implemented using a distributed computing environment. In some examples, the apparatus 400 may comprise a print apparatus. The display 412 may comprise a display of the print apparatus or a display device associated with the print apparatus. The display 412 is an optional component, as denoted by the dashed lines in FIG. 4.

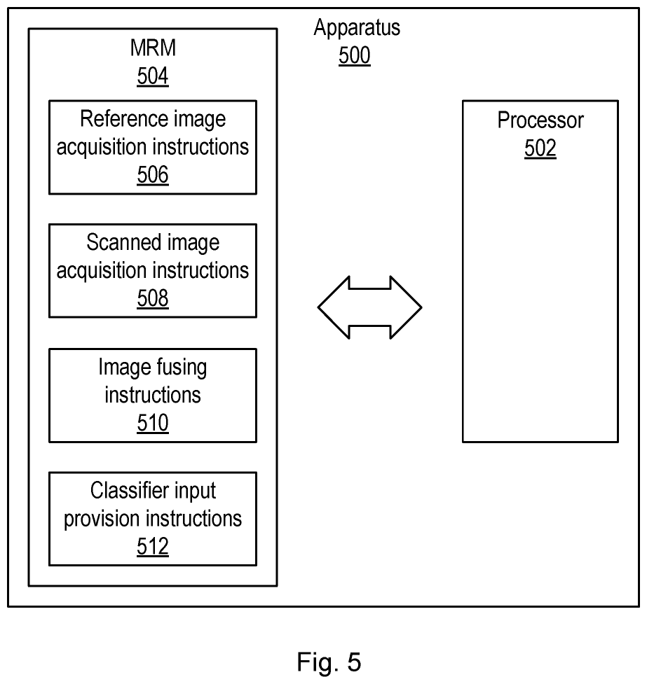

According to a further aspect, a machine-readable medium is disclosed. FIG. 5 is a simplified schematic of a processor 502 and a machine-readable medium 504. In the example shown, the processor 502 and the machine-readable medium 504 are included within an apparatus 500. The apparatus 500 may, for example, comprise or be similar to the apparatus 400 discussed above. The machine-readable medium 504 comprises instructions which, when executed by the processor 502, cause the processor to perform the methods disclosed herein. In one example, the machine-readable medium 504 comprises instructions which, when executed by the processor 502, cause the processor to acquire a reference image to be printed on printable media, and acquire a scanned image of printable media on which the reference image has been printed. Instructions to cause the processor 502 to perform these functions may include reference image acquisition instructions 506 and scanned image acquisition instructions 508. Further instructions, when executed by the processor 502, cause the processor to fuse the reference image and the scanned image into a fused image; and provide image data representing the fused image as an input into a neural network classifier component to detect and locate a difference between the reference image and the scanned image, the difference being indicative of a defect in the printed image. Instructions to cause the processor 502 to perform these functions may include image fusing instructions 510 and classifier input provision instructions 512. Fusing the images into a fused image may be achieved using the imaging combining techniques discussed herein.

In some examples, the machine-readable medium 504 may comprise instructions which, when executed by the processor 502, cause the processor to generate, based on an output of the neural network classifier component, a representation of the fused image including an indication of the location of the detected difference, for display to a user. The representation may, for example, be displayed on a display device associated with the processor 502.

Examples disclosed herein provide a method, an apparatus and a machine-readable medium for detecting differences in a reference image and a scan of a printed image. Any such detected difference may be indicative of a defect in a printed image, such as a defect resulting from the printing operation. By using a classifier component to detect a difference, to classify the difference as either a false alarm or a true defect, and to provide an indication of the location of the difference, may be possible to achieve a high degree of accuracy in detecting and locating differences in the images, and a relatively low number of false alarm events, as compared to previously-used techniques.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
obtaining first image data representing a reference image to be printed on a substrate;
obtaining second image data representing a scanned image of a substrate on which the reference image has been printed;
combining the first image data and the second image data to generate combined image data; and
providing the combined image data as an input to a classifier component to identify a difference between the first image data and the second image data.

2. A method according to claim 1, wherein the classifier component is to provide as an output an indication of a location of a difference between the reference image and the scanned image.

3. A method according to claim 1, wherein the classifier component is to provide as an output an indication that an identified difference between the reference image and the scanned image represents a defect in the scanned image.

4. A method according to claim 1, wherein the classifier component comprises a deep neural network.

5. A method according to claim 1, wherein combining the first image data and the second image data comprises:
converting the first image data into first grayscale image data;
converting the second image data into second grayscale image data;
applying the first grayscale image data as first and second channels of the combined image data; and
applying the second grayscale image data as a third channel of the combined image data.

6. A method according to claim 1, wherein combining the first image data and the second image data comprises applying principal component analysis to the first image data and the second image data.

7. A method according to claim 1, further comprising, prior to said combining:
registering the first image data with the second image data.

8. A method according to claim 1, further comprising:
responsive to the classifier component identifying a difference between the first image data and the second image data, delivering, for presentation to a user, the combined image data and an indication in the combined image data of a location of the identified difference.

9. A method according to claim 1, further comprising:
responsive to the classifier component identifying a difference between the first image data and the second image data, generating an alert to be provided to a user.

10. An apparatus comprising:
a data input unit to:
receive reference image data representing a three-channel reference image to be printed onto a printable substrate; and
receive scanned image data representing a three-channel scanned image of a printable substrate on which the reference image has been printed during a printing operation; and
processing apparatus to:
combine the reference image data and the scanned image data to form combined image data representing a three-channel combined image; and
input the combined image data into a classifier component to identify a difference between the reference image data and the scanned image data and to provide an indication of a location of the difference in the combined image.

11. An apparatus according to claim 10, wherein combining the reference image data and the scanned image data comprises:
converting the reference image data into grayscale reference image data;
converting the scanned image data into grayscale scanned image data;
setting the grayscale reference image data as first and second channels of the combined image data; and
setting the grayscale scanned image data as a third channel of the combined image data.

12. An apparatus according to claim 10, further comprising:
a display to display to a user the combined image and the indication of the location of the difference in the combined image.

13. An apparatus according to claim 10, wherein the apparatus comprises a print apparatus.

14. A machine-readable medium comprising instructions which, when executed by a processor, cause the processor to:
acquire a reference image to be printed on printable media;
acquire a scanned image of printable media on which the reference image has been printed;
fuse the reference image and the scanned image into a fused image; and
provide image data representing the fused image as an input into a neural network classifier component to detect and locate a difference between the reference image and the scanned image, the difference being indicative of a defect in the printed image.

15. A machine-readable medium according to claim 14, wherein, comprising
instructions which, when executed by a processor, cause the processor to:
generate, based on an output of the neural network classifier component, a representation of the fused image including an indication of the location of the detected difference, for display to a user.
